(19) United States
(12) Patent Application Publication
(10) Pub. No.: US 2005/0117654 A1
(43) Pub. Date: Jun. 2, 2005

(54) High-definition dual video decoder and decoding method, and digital broadcasting receiver using the same

(75) Inventor: Jin Seok Im, Gyeonggi-do (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 10/999,434

(22) Filed: Nov. 29, 2004

(30) Foreign Application Priority Data
Nov. 29, 2003 (KR) 10-2003-0085959

(51) Int. Cl. H04N 7/12

(52) U.S. Cl. 375/240.26; 375/240.01; 375/240.12; 375/240.03; 375/240.2

(57) ABSTRACT

A dual video decoder of a digital broadcasting receiver is provided. The decoder includes: a first PES decoder for decoding a first video PES outputted from a first system decoder, into a first video ES; a second PES decoder for decoding a second video PES outputted from a second system decoder, into a second video ES; a VBV (Video Buffer Verifier) buffer memory divided into a first video ES region and a second video ES region; a decoding controller for outputting a control signal to determine a to-be-decoded video ES among the first and second video ESs, and independently decode the first and second video ESs in a single decoding unit; and the single decoding unit for reading the to-be-decoded video ES from the corresponding region of the VBV buffer memory.

This application claims the benefit of the Korean Application No. 10-2003-0085959 filed on Nov. 29, 2003, which is hereby incorporated by reference.

### BACKGROUND OF THE INVENTION

1. Field of the Invention

The present invention relates to a digital broadcasting receiver for restoring a digital video compressed according to a standard of a Moving Picture Experts Group (MPEP), and more particularly, to a dual video decoder and a decoding method in which two High-Definition (HD) videos transmitted through different paths or channels are concurrently restored and displayed on a screen by using one video decoder.

2. Discussion of the Related Art

Moving Picture Experts Group (MPEP) standard, which is widely used as a moving picture compression way in a variety of field, is classified into a profile and a level depending on its application purpose. Accordingly, in order to embody a high quality of video, the moving picture should be encoded in a video size and a bit rate, which are determined depending on a MP@HL (Main Profile High Level) standard of the MPEG. The high quality of video is called a high definition video.

In a basic concept of the MPEG moving picture compression, Discrete Cosine Transforming (DCT) and Quantization are used to eliminate a spatial redundancy, and motion estimation-compensation is used to eliminate a temporal redundancy. A complexity of a decoder for restoring the compressed video is determined by a size of an Inverse Discrete Cosine Transformer (IDCT) and a size of a motion compensating circuit proportional to the video.

Even though encoding is performed using the MPEG, which is a technology of digital video compression generally having a good compression efficiency, a large size of an operational circuit and a complicated controlling circuit are required to embody a video decoder for restoring the HD video with much data in real time.

FIG. 1 illustrates a general video decoder, which can decode a digital broadcasting transmitted over one channel. Further, one of application field in which the moving picture compression way using the MPEG standard is successfully commercialized is a digital TV broadcasting such as ATSC, DVB and ARIB. In FIG. 1, the flow of video data is mainly divided into an IDCT portion and a motion compensation portion. Among several main construction blocks, sizes of the two portions act as a main role of determining the complexity of the video decoder. Accordingly, a cost and a performance of the video decoder depend on whether or not how much precisely and effectively the two portions are designed.

In other words, referring to FIG. 1, transmitted video bit stream is decoded in a Variable Length Decoder (VLD) 101 to be separate into a motion vector, a quantization value and a DCT coefficient. Here, the quantization value and the DCT coefficient are outputted to an Inverse Scan/Inverse Quantizer (IS/IQ) 102, and the motion vector is outputted to the motion compensating unit 106.

In the IS/IQ 102, data, which is inputted in a zig-zag scanning way or an alternate scanning way, is inversely scanned in a raster scanning way, and the inversely scanned DCT coefficient is quantized depending on the quantization value and then the quantized DCT coefficient is outputted to the IDCT unit 104 through a coefficient buffer 103. The IDCT unit 104 transforms the inversely quantized DCT coefficient to output the transformed DCT coefficient to an adder 105.

Alternately, the motion compensating unit 106 compensates a current pixel value by using the motion vector and a reference frame stored in a frame memory 100, and then outputs the compensated pixel value to the adder 105 through a prediction buffer 108.

The adder 105 adds the IDCT value and the motion-compensation value to entirely restore and output the video for displaying and at the same time, again store the outputted video in the frame memory 100 through a store buffer 107 for motion compensation.

As a digital TV broadcasting is set on its way, a digital television (TV) with a variety of functions appears in a market according to a variety of viewer's requests. One of the requests is to allow the viewer to concurrently view over two channels on one screen. This can be embodied on a TV screen such as a split screen and a Picture In Picture (PIP). In order to concurrently decode a digital TV moving picture inputted through two channels and concurrently display the decoded moving picture on the screen, two video decoders are required to decode the video signal of each of the channels.

The video decoders should be able to independently and stably control the moving picture of each channel. This is essential to provide a variety of channel selection to a user without an abnormal image of the screen. At this time, decoded moving picture of two channels can be also displayed on the TV screens different from each other, and two screens can be also combined and displayed at one TV. For example, in the display mode in which the moving pictures of the two channels can be viewed through one TV screen, there are the split screen for allowing the screen to be split and viewed left and right, and the PIP for providing a small screen in a large screen.

As shown in FIG. 2, conventional two video decoders are used to perform the decoding for two channels.

In other words, first and second tuners 201 and 204, which are respectively in charge of the channels, tune a frequency at a user's tuning channel from a TV signal received through an antenna, and respectively output the tuned frequency to the first and second system decoders 202 and 205. Transport Streams outputted from the first and second tuners 201 and 204 are digital packet data to which a modulated TV signal is restored in a transport format. The first and second system decoders 202 and 205 disassemble a video packet corresponding to a desired program from the TS packet and decode the disassembled video packet into a video Packetized Elementary Stream (PES), and then output the decoded PES to the first and second video decoders 203 and 206.

The first and second video decoders 203 and 206 respectively decode the inputted video PES by using an MPEG decoding algorithm and then, output the decoded PES to a screen combining unit 207. At this time, the first and second video decoders 203 and 206 have the same internal constructions as FIG. 1.

In other words, the two video decoders of FIG. I are required to concurrently perform the decoding for the two channels. At this time, since the first and second video decoders 203 and 206 are separated from each other, they do not have a mutual relation and do not cause a mutual interference. Therefore, the two channels can be individually and stably operated. Additionally, since the decoded two moving pictures can be variously combined and displayed without image loss even on an actual screen through the screen combining unit 207, it can allow the viewer to variously select the display mode.

However, when the dual video decoding for the two channels is performed as described above, two video decoders should be used. Accordingly, a cost is increased.

Another conventional invention has been filed by this applicant on Jan. 12, 2000 and assigned an application No. 2000-0001414. In order to improve a drawback of a high cost of the above-described conventional art, one decoder is used to perform the decoding for the two channels. That is, in the above conventional invention, the moving pictures constructing the two channels are split in a predetermined separable time unit or spatial unit (for example, picture or macro block) to alternately perform the decoding for the two channels.

However, the conventional art has a difficulty in stably performing the decoding for the two channels without the image loss. Specifically, the conventional art has a drawback in that in case where an error such as a bit stream underflow is generated at one channel, a mutual interference causes a critical pervasive effect on other channels.

In other words, the conventional invention has a drawback in that when two HD video signals are concurrently decoded, and the underflow is generated and maintained in the buffer due to an erroneous channel or an erroneous Vestigial SideBand (VSB) reception chip, a VBV buffer is erroneously controlled while an overflow is generated, thereby causing the image loss such as image stop or image breakdown.

### SUMMARY OF THE INVENTION

Accordingly, the present invention is directed to a High-Definition (HD) dual video decoder and a decoding method, and a digital broadcasting receiver using the same that substantially obviate one or more problems due to limitations and disadvantages of the related art.

An object of the present invention is to provide a HD dual video decoder and a decoding method in which a drawback of a high cost and an unstable operation caused by a mutual interference of a dual video can be solved.

Another object of the present invention is to provide a HD dual video decoder and a decoding method in which main construction blocks are shared and a dual video decoding is performed with synchronization to a display synchronous signal to independently decode two HD videos in different conditions of a transmission environment, a bit rate, a frame rate and the like without image loss.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a dual video decoder of a digital broadcasting receiver having first and second system decoders for decoding and outputting first and second video PESs (Packetized Elementary Streams) from TS (Transport Stream) bit streams of channels concurrently tuned and demodulated through first and second tuners, the decoder including: a first PES decoder for decoding the first video PES outputted from the first system decoder, into a first video ES; a second PES decoder for decoding the second video PES outputted from the second system decoder, into a second video ES; a VBV (Video Buffer Verifier) buffer memory divided into a first video ES region and a second video ES region, for temporarily storing the first and second video ESs outputted from the first and second PES decoders, in corresponding first video ES region and second video ES region; a decoding controller for, if a decoding mode and a display mode having image information are set, outputting a control signal to determine a to-be-decoded video ES among the first and second video ESs, and independently decode the first and second video ESs in a single decoding unit by using a display synchronous signal; and the single decoding unit for reading the to-be-decoded video ES form the corresponding region of the VBV buffer memory in a predetermined unit of decoding under the control of the decoding controller to restore the read video ES to an original video signal through VLD (Variable Length Decoding) with synchronization to the display synchronous signal, IQ (Inverse quantizing), IDCT (Inverse Discrete Cosine Transforming), and MC (Motion Compensating).

The decoder further includes a screen combining unit for combining and outputting first and second video signals, which are dual-decoded and outputted in a video frame unit from the single decoding unit, in the display mode.

An input signal of the decoding controller at least has decoding mode information, display mode information, a frame rate and scanning information of a moving picture.

The control signal outputted from the decoding controller to the decoding unit has a decoding mode signal indicating a single video decoding mode or a dual video decoding mode, and identification information (ID) included in the to-be-decoded video ES.

The display mode information outputted from the decoding controller to a displaying unit at least has a size of a picture to be displayed, a display mode, and memory position information of a video frame.

The video signal of each of the channels tuned through the first and second tuners has a different frame rate or the same frame rate as the display synchronous signal.

Each of the video ESs is decoded in a video frame unit in the dual video decoding mode.

The decoding controller controls the frame rate of a corresponding video frame being currently decoded, by using a display field number (display_number), the display field number being the number of the display synchronous signal that allow the displaying of the restored picture.

The decoding controller allocates one of 0, 1, 2 and 3 as the display field number (display_number) depending on the frame rate every display frame of each video bit stream, and reduces a corresponding display field number (display_number) whenever a corresponding decoded video frame is outputted.

The decoding controller outputs the corresponding decoded video frame with the display field number (display_number) of ‘0’ most prioritized.

If a condition of display_number<2 is satisfied in the single video decoding mode and a condition of display_number<3 is satisfied in the dual video decoding mode, the decoding controller controls the single decoding unit to decode the corresponding video frame with synchronization to the display synchronous signal.

The decoding controller allows a parity consistence of a display field of video decoded in the decoding unit, and outputs the decoded video.

A field delay is performed by at least one field for a duration from the decoding to the displaying in the single video decoding mode and is performed by at least one field or two fields for the duration from the decoding to the displaying depending on the frame rate and a decoding synchronous signal duration of each video in the dual video decoding mode, in order to allow the consistence of the display field.

In case where a source of a to-be-decoded video frame is an interlaced scanning, and a to-be-currently-displayed field parity for the to-be-decoded video frame and a field parity of the display synchronous signal is not consistent with each other, the decoding controller suspends the decoding of the to-be-decoded video frame to allow the consistence of the two fields parity.

In case where the display synchronous signal of 30 Hz is used, the decoding controller decodes two video frames of a compression moving picture having frame rates of 59.94 and 60 frames/sec for one display synchronous signal duration in the dual video decoding mode.

In another aspect of the present invention, there is provided a dual video decoding method of a digital broadcasting receiver in which first and second video ESs are extracted from video PESs of first and second channels, which are concurrently tuned and demodulated through first and second tuners, and stored in a VBV (Video Buffer Verifier) buffer memory, and the stored first and second video ESs are decoded through a single video decoder, the method including the steps of: (a) if a decoding mode and a display mode having image information are set, determining a to-be-decoded video ES among the first and second video ESs, and waiting a predetermined transition state of a display synchronous signal; (b) checking the frame rate of the determined to-be-decoded video ES by using a display field number (display_number) determined suitably to the display synchronous signal in a transition state of the display synchronous signal, and performing a next decoding or waiting without the decoding until a next display synchronous signal duration; (c) decoding picture header information of a corresponding video frame in case where it is determined that a previous decoding is not in a suspended state by using an indication signal informing of suspended decoding, and bypassing the decoding of the picture header information in case where it is determined that the previous decoding is in the suspended state; (d) comparing a DTS (Decoding Time Stamp), which is inserted into the corresponding video frame, with a STC (System Time Clock), which is calculated by an entire reference clock of the receiver, to determine whether or not to correspond to any one of waiting, skip and decoding states; (e) in case where it is determined to correspond to the waiting state, setting the indication signal, which informs of the suspended decoding, to ‘1’, and waiting without the decoding until the next display synchronous signal duration; and (f) skipping the decoding of the determined to-be-decoded video ES in a predetermined unit of decoding in case where it is determined to correspond to the skip state, and performing the determined to-be-decoded video ES in a video frame unit in case where it is determined to correspond to the decoding state.

In the (b) step, the next decoding is performed to synchronize the corresponding video frame to the display synchronous signal to decode the synchronized corresponding video frame in case where a condition of display_number<2 is satisfied in a single video decoding mode and a condition of display_number<3 is satisfied in a dual video decoding mode, and waiting without the decoding until the next display synchronous signal duration in case where the conditions are not satisfied.

The (f) step includes the steps of: in case where it is determined that the inputted source is an interlaced scanning moving picture while being in the decoding state in the (d) step, checking whether or not a to-be-currently-displayed field parity for each video bit stream and a field parity of the display synchronous signal is consistent with each other; and only in case where it is determined that two fields parity is consistent, decoding the corresponding video frame, and in case where it is determined that they is not consistent, setting the indication signal to ‘1’ and suspending the decoding until the next display synchronous signal duration.

In case where the display synchronous signal of 30 Hz is used, the decoding controller decodes two video frames of a compression moving picture having frame rates of 59.94 and 60 frames/sec for one display synchronous signal duration in the dual video decoding mode.

The (a) step further includes a step of waiting until the next display synchronous signal duration if the video ES sufficient for decoding is not stored in the VBV buffer memory.

In a further another aspect of the present invention, there is provided a digital broadcasting receiver including: a first tuner for tuning one of a plurality of channel signals received through an antenna, to demodulate the tuned channel signal to a first TS (Transport Stream) bit stream; a second tuner for tuning one of the plurality of channel signals received through the antenna, to demodulate the tuned channel signal to a second TS bit stream; a first system decoder for decoding a first video PES from the demodulated first TS bit steam, and outputting the decoded first video PES; a second system decoder for decoding a second video. PES from the demodulated second TS bit steam, and outputting the decoded second video PES; a single video decoder for decoding each of the first and second video PESs outputted from the first and second system decoders into the video ESs, and determining a to-be-decoded video ES among the first and second video ESs depending on the decoding mode and the display mode, and decoding the determined to-be-decoded video ES in a video frame unit at a predetermined transition state of a display synchronous signal; and a screen combining unit for combining and outputting first and second video signals, which are dual-decoded and outputted in the video frame unit from the single video decoder, in the display mode.

The single video decoder includes: a first PES decoder for decoding the first video PES outputted from the first system decoder, into the first video ES; a second PES decoder for decoding the second video PES outputted from the second system decoder, into the second video ES; a VBV (Video Buffer Verifier) buffer memory divided into a first video ES region and a second video ES region, for temporarily storing the first and second video ESs outputted from the first and second PES decoders, in corresponding first video ES region and second video ES region; a decoding controller for, if the decoding mode and the display mode having image information are set, outputting a control signal to determine the to-be-decoded video ES among the first and second video ESs, and independently decode the first and second video ESs in a decoding unit by using the display synchronous signal; and the decoding unit for reading the to-be-decoded video ES from the corresponding region of the VBV buffer memory in a predetermined unit of decoding under the control of the decoding controller to restore the read video ES to an original video signal through VLD (Variable Length Decoding) with synchronization to the display synchronous signal, IQ (Inverse quantizing), IDCT (Inverse Discrete Cosine Transforming), and MC (Motion Compensating).

The decoding controller controls to wait until a next display synchronous signal duration if the video ES sufficient for decoding is not stored in the VBV buffer memory.

The decoding controller controls to check whether or not a to-be-currently-displayed field parity for each video bit stream and a field parity of the display synchronous signal is consistent, and if it is determined that they is not consistent, the decoding controller controls to suspend the decoding until the next display synchronous signal duration.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a general video decoder;

FIG. 2 is a block diagram illustrating a general digital broadcasting receiver having two-channel video decoder;

FIG. 3 is a schematic view illustrating a digital broadcasting receiver having a two-channel video decoder according to the present invention;

FIG. 4 is a detailed block diagram illustrating a two-channel video decoder of FIG. 3;

FIG. 5 is an operation flowchart of a decoding controller of FIG. 4;

FIG. 6(a) is a view illustrating an example of single video decoding and displaying in which a moving picture is based on an interlaced scanning way, a frame rate has 30 frames/sec and odd-number scanning is prioritized according to the present invention;

FIG. 6(b) is a view illustrating an example of single video decoding and displaying in which a moving picture is based on a progressive scanning way and a frame rate has 24 frames/sec according to the present invention;

FIG. 6(c) is a view illustrating an example of single video decoding and displaying in which a moving picture is based on a progressive scanning way and a frame rate has 60 frames/sec according to the present invention;

FIG. 7 is a view illustrating an example of dual video decoding and displaying in which a 24-frame moving picture is based on a progressive scanning way and a 30-frame moving picture is based on an interlaced scanning way according to the present invention;

FIG. 8 is a view illustrating an example of dual video decoding and displaying in which a 60-frame moving picture is based on a progressive scanning way and a 30-frame moving picture is based on an interlaced scanning way according to the present invention; and

FIG. 9 is a view illustrating an example of dual video decoding and displaying with a 60-frame moving picture is based on a progressive scanning way and a 24-frame moving picture is based on a progressive scanning way according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

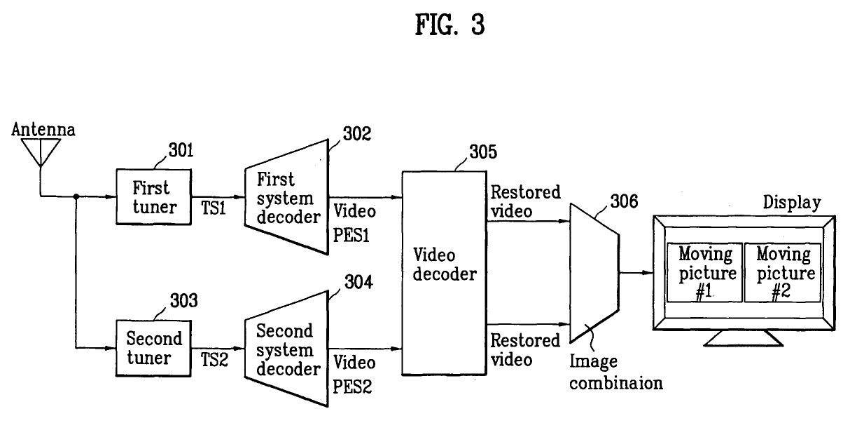

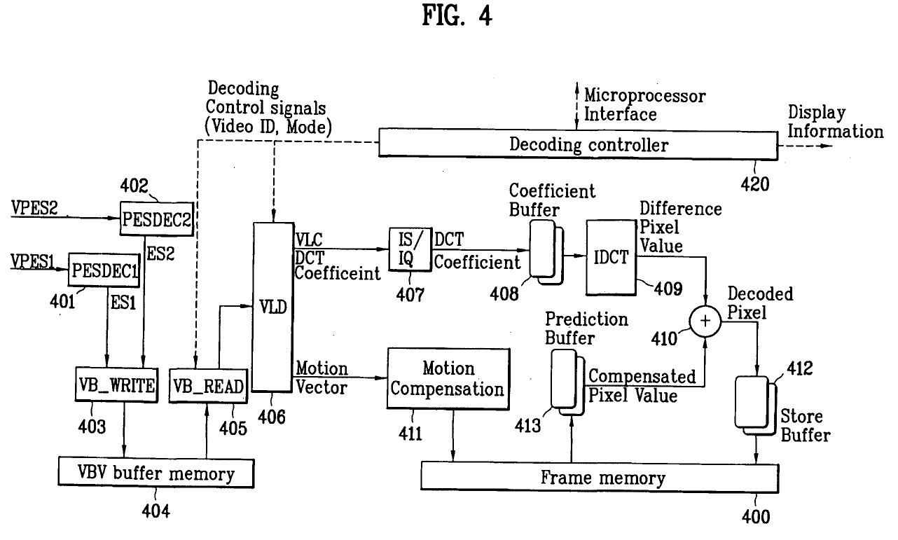

FIG. 3 is a whole schematic view illustrating a digital broadcasting receiver having a two-channel video decoder according to the present invention, and FIG. 4 is a detailed block diagram illustrating a two-channel video decoder of FIG. 3.

Referring to FIG. 3, the digital broadcasting receiver includes two tuners 301 and 303, system decoders 302 and 304, and one video decoder 305 to concurrently decode two High-Definition (HD) video signals.

The video decoder 305 additionally includes a screen combining unit 306 at its output terminal to combine and display concurrently the decoded two HD video signals.

The video decoder 305 shares main blocks as shown in FIG. 4, and allows the dual video decoding under the control of the decoding controller 420. In other words, the decoding controller 420 controls internal blocks of the video decoder 305 to perform the dual video decoding with synchronization to a display synchronous signal (display_sync).

Referring to FIG. 4, the video decoder 305 includes the decoding controller 420 for controlling the single video decoding and the dual video decoding; a first Packetized Elementary Stream (PES) decoder 401 for decoding a first video Packetized Elementary Stream (VPES1) outputted from the first system decoder 302, into a video Elementary Stream (ES); a second PES decoder 402 for decoding a second video PES (VPES2) outputted from the second system decoder 304, into a video ES; a Video Buffer Verifier (VBV) buffer memory 404 for temporarily storing the first and second video ESs; a buffer memory write controlling unit 403 for writing the first and second video ESs in corresponding regions of the VBV buffer memory 404; and a buffer memory read controlling unit 405 for reading the corresponding video ES stored in the VBV buffer memory 404 to output the read video ES to a Variable Length Decoding (VLD) unit 406 under the control of the decoding controller 420.

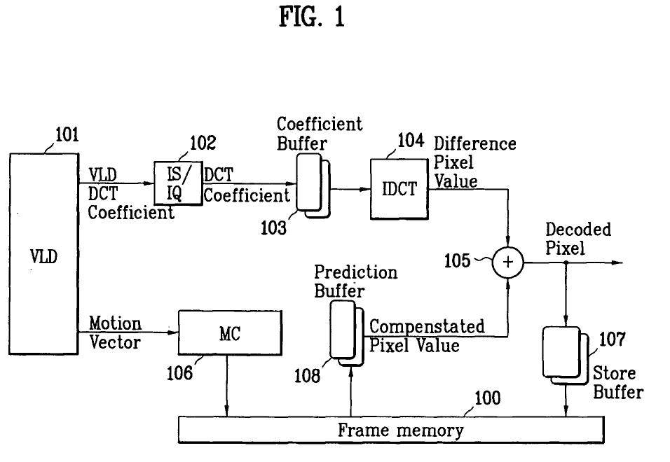

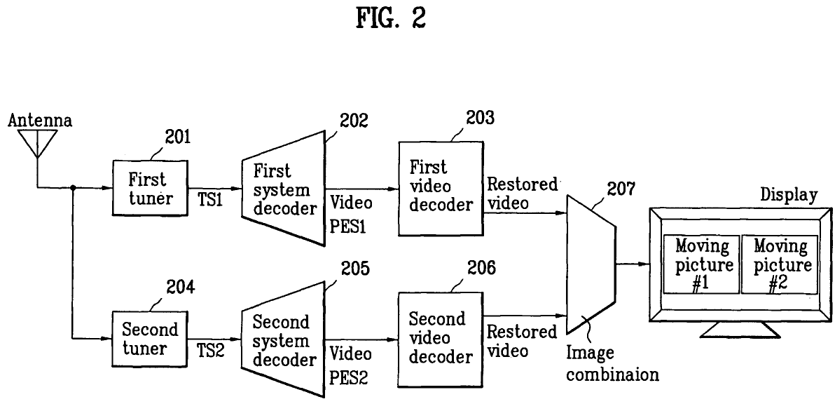

Further, as shown in FIG. 1, the video decoder 305 additionally includes the VLD unit 406, an Inverse Scanning/Inverse Quantizing (IS/IQ) unit 407, a coefficient buffer 408, an Inverse Discrete Cosine Transforming (IDCT) unit 409, an adding unit 410, a motion compensating unit 411, a store buffer 412, a prediction buffer 413, and a frame memory 400.

Here, the VBV buffer memory 404 and the frame memory 400 are installed inside or outside the video decoder, and are respectively divided into video bit stream regions. In other words, one video bit stream means one program, and an n-number of video bit streams means an n-number or less number of programs. This is because the same program can be duplicated in the n-number of the video bit streams.

Additionally, the present invention provides four or more frame memories used for the dual video decoding without an image breakdown in a dual video decoding mode.

In FIG. 4, a data flow of a video PES (VPES), a video ES, a DCT coefficient, a motion vector, a decoded pixel and the like is represented using a solid line. A control signal such as a decoding control signal, a microprocessor interface, and display information is represented using a dot line.

In the inventive above-construction, a RF signal of a channel tuned through the first tuner 301 is demodulated in a Transport Stream (TS) packet format, and inputted to the first system decoder 302. In the same manner, a RF signal of a channel tuned through the second tuner 303 is demodulated in the TS packet format, and inputted to the second system decoder 304. Here, the RF signals of the channels tuned through the first and second tuners 301 and 303 can be all also HD signals. Or, only any one of them can be also a HD signal.

The first and second system decoders 302 and 304 have the same construction and function. One of the first and second system decoders 302 and 304 is described below.

The system decoder disassembles the TS packet, which is outputted through the tuner, into an audio PES, the video PES and a data PES, suitably to a Program ID (PID) of the channel.

In other words, since MPEG-2 video and audio, and data bit stream are multiplexed, the MPEG-2 video and audio, and the data bit stream are respectively disassembled into the video PES and the audio PES, and the data PES in the system decoder. Additionally, the video PES is outputted through the video decoder 305. Since the audio PES and data PES is not a feature of the present invention, a description thereof is omitted.

The video decoder 305 extracts the video bit stream of an ES format from the video PES packet, and then stores the extracted video bit stream in the memory. At this time, the bit stream region of each video is divided on the memory. Additionally, the video decoder 305 sequentially reads and decodes the video bit stream from the memory according to the display synchronous signal and a unit of decoding, to output the decoded video bit stream to a displaying unit through the image combining unit 306.

According to the present invention, there are a single video decoding mode in which only one video signal is decoded, and a dual video decoding mode in which two video signals are concurrently decoded. That is, in the single video decoding mode, only one channel is tuned through one tuner. In the dual video decoding mode, at least one channel is tuned through two tuners for a split screen or a Picture in Picture (PIP). Here, the channels tuned through two tuners can be the same or different from each other.

The video decoder 305 uses a video frame as the unit of the decoding of each video in the dual video decoding mode.

Additionally, a term of “video identifier (ID)” is used to distinguish each video bit stream of the dual video. In an embodiment, the video ID has a value of 1 or 2. Since this value can be differently designed depending on a designer, the value is not limited to the above embodiment.

At this time, a corresponding video frame of the selected video ID is restored through a general data path irrespective of the single video decoding mode and the dual video decoding mode. In the single video decoding mode, the decoding is controlled differently from the dual video decoding mode for a little more stable operation.

In the dual video decoding mode, the video decoder 305 shares main operational circuit and control circuit, and performs the dual video decoding with synchronization to the display synchronous signal, thereby restoring two compressed moving pictures inputted through the different channels or paths with their independencies maintained to the maximum.

In other words, in the dual video decoding mode, the display synchronous signal (display_sync signal) is used to separate the dual video decoding so that the separated dual video decoding different from one another are not influenced by an erroneous bit stream of each video, an erroneous underflow or overflow in transmission, and an erroneous decoding.

At this time, “display_number” is used as means for controlling the frame rate during the decoding to display the restored moving picture without image cutoff or image delay. The “display_number” is the number of the display synchronous signals, which should allow the display of the restored image.

The display_number has a value of 0, 1, 2 or 3. When a condition of display_number<2 is satisfied in the single video decoding mode and a condition of display_number<3 is satisfied in the dual video decoding mode, the video decoder 305 decodes the corresponding video frame with synchronization to the display synchronous signal.

In other words, the display field number (display_number) is allocated every display frame of each video bit stream so as to time-multiplex and decode the video bit stream of a variety of frame rates and film modes in a video frame unit. The display_number is different depending on a frame rate and film mode signal to be dual-video-decoded. At this time, the decoding controller 420 time-multiplexingly outputs the video bit stream having a display field number of 1 prioritized, with synchronization to the display synchronous signal (display_sync), and then reduces a corresponding display field number (display_number) by one to represent a display state.

Further, when the restored video is displayed under the decoding control, a parity of a display field is consistent to display the restored video on a screen, thereby preventing the degradation of a picture quality. In order to satisfy the above condition, a field delay for a duration from the decoding to the displaying is performed by one field in the single video decoding mode, and is performed by one or two fields depending on the frame rate and a decoding synchronous signal duration of each video in the dual video decoding mode.

In other words, in the interlaced scanning way, even the field parity should be consistent for displaying. Therefore, in case where a source of the video bit stream is the interlaced scanning, the decoding controller 420 checks whether or not the field parity to be currently displayed for the video bit stream is consistent with the field parity of the display synchronous signal (display_sync), to perform the decoding for the consistence of the field parity. At this time, in case where the field parity is not consistent in the single video decoding mode, and the decoding is preformed for a next display synchronous signal duration, the field parity is consistent. For example, in case where the field parity is not consistent at a display synchronous signal (display_sync) of ‘0’, if it is waited until a display synchronous signal of ‘1’ and the decoding is performed, the field parity become consistent. Accordingly, if it is waited for the duration of one display synchronous signal, a repetition effect is provided as a result. During the duration of the one display synchronous signal, the display field number (display_number) of ‘0’ is not any more reduced.

Additionally, two frames of the compression moving picture are decoded at the frame rates of 59.94 and 60 frames/sec for the duration of one display synchronous signal (display_sync) to prevent erroneous diffusion between the videos and maintain a normal frame rate.

Hereinafter, a detailed description of a video decoding process according to the present invention is made with reference to FIGS. 4 to 9.

In other words, in FIG. 4, the video decoder 305 receives the decoded video PES packets from the first and second system decoders 302 and 304, and finally outputs video frame information to be displayed.

The decoding controller 420 controls an entire operation of the video decoder 305. That is, if a microprocessor (not shown) sets the decoding mode (single video decoding mode or dual video decoding mode), the display mode and the like, which are necessary for operation, the decoding controller 420 control the internal blocks of the video decoder 305. The decoding control signal outputted to the buffer memory read controlling unit 405 and the VLD 406 includes information on the decoding mode, the selected video ID and the like. Display information outputted to the displaying unit includes a size of image to be displayed, the display mode (PIP and split screen), a memory position of the video frame, and the like.

The first PES decoder 401 decodes the video PES, which is outputted from the first system decoder 302, into the video ES, and then writes the decoded video ES in the corresponding regions of the VBV buffer memory 404 through the buffer memory write controlling unit 403. The second PES decoder 402 decodes the video PES, which is outputted from the second system decoder 304, into the video ES, and then writes the decoded video ES in the corresponding regions of the VBV buffer memory 404 through the buffer memory write controlling unit 403. Additionally, as one example, it is assumed that the video ID of the video ES outputted from the first PES decoder 401 is set to ‘1’, and the video ID of the video ES outputted from the second PES decoder 402 is set to ‘2’.

The VBV buffer memory 404 is divided depending on the video ID. The buffer memory write controlling unit 403 designates a position on the memory for storing the video ES according to the video ID of the inputted video ES, and controls a storage process.

Additionally, the video ES stored in the VBV buffer memory 404 is outputted to the VLD unit 406 through the buffer memory read controlling unit 405. That is, according to a request of the VLD unit 406, the buffer memory read controlling unit 405 reads a corresponding bit stream from the memory for storing the to-be-decoded video ES, and transmits the read bit stream to the VLD unit 406.

The VLD unit 406 analyzes a syntax structure of the MPEG standard to extract the DCT coefficient and the quantization value necessary for restoring the video, and the motion vector from the inputted bit stream.

The quantization value and the DCT coefficient are outputted to the IS/IQ unit 407, and the motion vector is outputted to the motion compensating unit 411.

The IS/IQ unit 407 inversely scans data, which is inputted in a zig-zag scanning way or an alternate scanning way, in a raster scanning way, and inversely quantizes the inversely scanned DCT coefficient according to the quantization value. After that, the IS/IQ unit 407 outputs the inversely quantized DCT coefficient to the IDCT unit 409 through the coefficient buffer 408. The IDCT unit 409 performs the IDCT for the inversely quantized DCT coefficient to restore a difference pixel value and output the restored difference pixel value to the adding unit 410.

Meanwhile, the motion compensating unit 411 reads the motion vector and a previous frame, that is, a compensated pixel value, from the frame memory 400 to perform the motion compensation for the current pixel value and output the compensated pixel value to the adding unit 410 through the prediction buffer 413.

The adding unit 410 adds an IDCT value and a motion-compensated value, that is, the difference pixel value and the compensated pixel value, to entirely restore the video, which is a final pixel value, and then stores the restored video in the frame memory 400 through the store buffer 412.

Restored pixels can construct and display one whole restored video. If each of the video frames is completely restored, the decoding controller 420 transmits a storage position of the video and its relating information to the displaying unit to display them on the screen.

The decoding controller 420 controls an entire operation of the video decoder according to the decoding mode with synchronization to the display synchronous signal (display_sync), which is a display reference signal. This is to control the video decoding with reference to the video displayed on the screen. Additionally, a digital TV standard such as ATSC, ARIB and the like has typical frame rates of 24, 30 and 60 frames/sec, and has the same class of frame rates of 23.976, 29.97 and 59.94 frames/sec. In other words, the decoding controller 420 controls the dual video decoding by using the display synchronous signal (display_sync) of 30 Hz for the frame rate of the moving picture outputted from the microprocessor and for all frame rates by an analysis of interlace sequence and progressive sequence information.

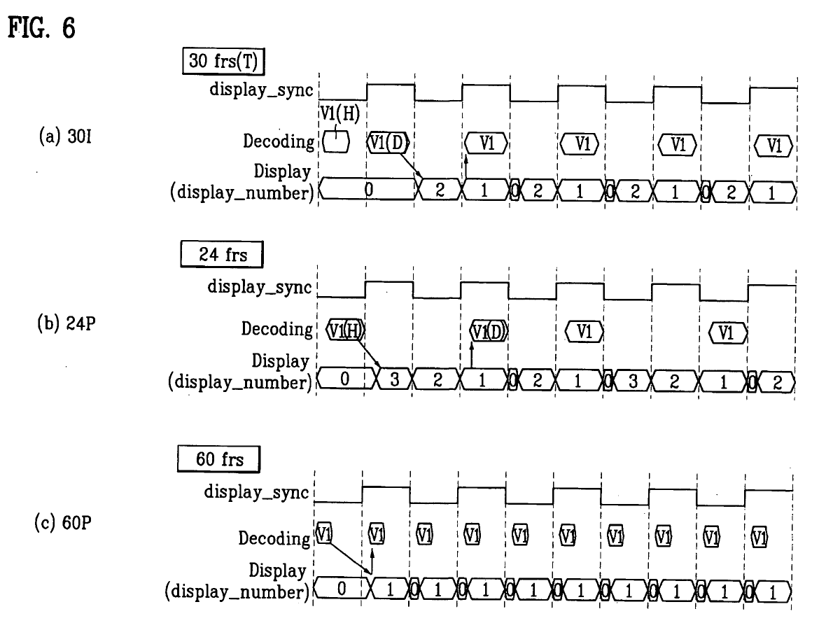

For example, at the frame rate of 30 frames/sec, the decoding is performed by using the display synchronous signal (display_sync) of 30 Hz, and the display field number (display_number), which is the number of the field to be displayed, has a value of 0, 1 or 2 as shown in FIG. 6.

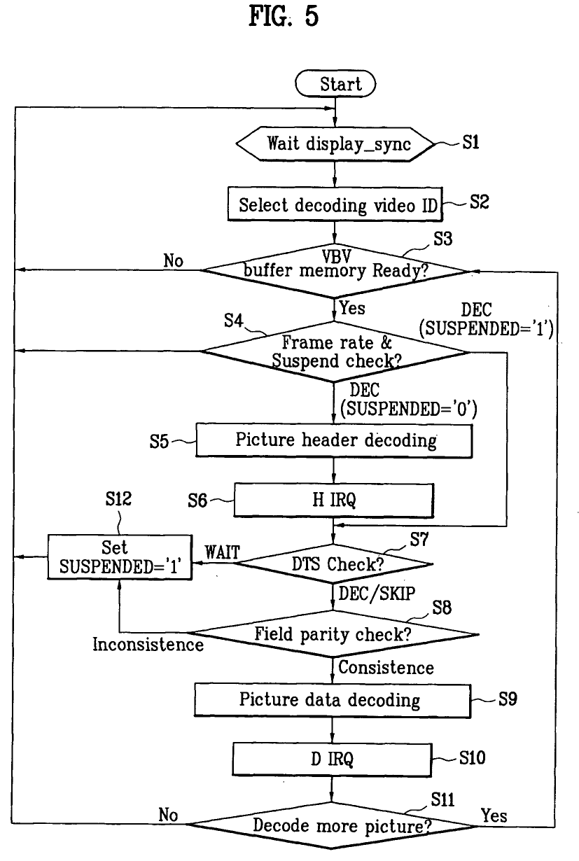

FIG. 5 is an operation flowchart of the decoding controller 420 of FIG. 4.

In other words, the video is restored with synchronization to the display synchronous signal (display_sync) irrespective of the decoding mode. In a step of S1, a transition state of the display synchronous signal (display_sync) is waited to synchronize the decoding.

And then, the to-be-decoded video ID is selected (S2). At this time, in the single video decoding mode, the video ID does not need to be separated and selected. That is, only in the dual video decoding mode, the video ID is selected depending on the display synchronous signal (display_sync) duration. A difference caused by a different decoding duration is a field delay for the duration from the decoding to the displaying.

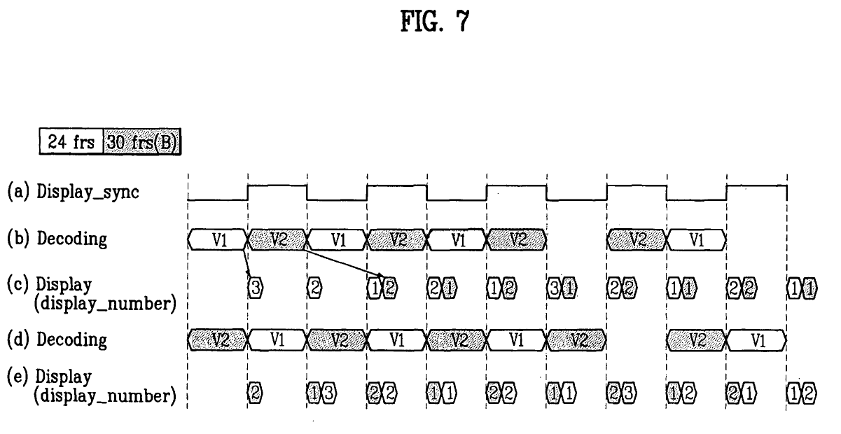

For example, FIG. 7 illustrates a dual video decoding process of a 24-frame moving picture (V1) and a 30-frame moving picture (V2). At decoding-display timings of (b) and (c), the moving picture (V1) is decoded for the display synchronous signal (display_sync) duration of 1, and the moving picture (V2) is decoded for the display synchronous signal (display_sync) duration of 0. At decoding-display timings of (d) and (e), each of the video ID is decoded for the display synchronous signal (display_sync) duration.

Additionally, if underflow is generated at the VBV buffer memory 404 during the video frame decoding, the image breakdown is caused. Therefore, the decoding controller 420 is operated while checking a state of the VBV buffer memory 404 (S3). That is, in the S3, the decoding controller 420 checks the VBV buffer memory 404 whether or not the video ES is sufficiently prepared for the decoding. If the video ES is not sufficiently prepared for the decoding, it returns to the S1 to wait until the next display synchronous signal (display_sync) duration and again perform the decoding. Additionally, if the video ES is sufficiently prepared for the decoding in the VBV buffer memory 404, a next step S4 is performed.

In the S4, the video frame rate is checked and also, it is checked whether or not the decoding is suspended. The frame rate is checked using the display field number (display_number), which is determined with synchronization to the display synchronous signal of 30 Hz. The display field number (display_number) has a value of 0, 1, 2 or 3. If the condition of display_number<2 is satisfied in the single video decoding mode or the condition of display_number<3 is satisfied in the dual video decoding mode, the picture header information is decoded in a step of S5 and the header interrupt is generated in a step of S6. If the display_number does not satisfy the above condition, it returns to the S1 to wait until the next display synchronous signal (display_sync) duration and again perform the decoding.

Additionally, if a suspended signal indicating a suspended state of a previous decoding is ‘1’ in the S4, a step S7 is performed to check a Decoding Time Stamp (DTS). Otherwise, the S5 is performed to decode the picture header information and the S6 is performed to generate the header interrupt and then, the S7 is performed to check the DTS.

A detailed description of the display_number will be again described later.

In the S5, the VLD unit 406 is operated to read the bit stream from the VBV buffer memory 404, thereby decoding the header information. The VLD unit 406 decodes the header information such as the frame rate, a picture coding type, a picture structure and a display characteristic of the moving picture, from the bit stream.

After the picture header decoding is finished, the interrupt is generated in the microprocessor in the S6. The microprocessor sets the decoding mode suitably to a characteristic of the moving picture in an interrupt process or resets the memory region to control necessary general items for the decoding.

In the S7, the DTS of the corresponding video frame inserted on the bit stream is compared with a System Time Clock (STC) calculated by an entire reference clock of the receiver to check whether or not the compared value is within a predetermined range. If the compared value is within the predetermined range, the decoding is performed in a step S9 after a step S8 is preformed. That is, if the DTS is in a very large “SKIP” condition comparing to the STC or is in a decoding condition informing a normal decoding range through the DTS check, the decoding is continuously performed. If the DTS is in a very small “WAIT” condition comparing to the STC, the suspended signal informing the suspended decoding is set to ‘1’ and suspends the decoding until the next display synchronous signal (display_sync) duration in a step of S12.

In the step of S8, the display synchronous signal (display_sync) duration is checked to allow the consistence of the parity of the display field. For this, the decoding controller 420 checks whether or not the field parity to be currently displayed for each of the video bit stream is consistent with the field parity of the display synchronous signal (display_sync). At this time, in case where they is not consistent with each other, the suspended signal is set to ‘1’ and the decoding is suspended until the next display synchronous signal (display_sync) duration. In this case, the display field number (display_number) is not reduced.

In other words, when the restored video is displayed by the decoding control, the parity of the display field is consistent to output the restored video on the screen, thereby preventing the degradation of the picture quality. Specifically, in case of the interlaced scanning moving picture, if the parity of the display field is not consistent, for example, if an even-number scanning is performed for a duration for which an odd-number scanning should be performed (that is, for the duration of the display synchronous signal of ‘0’), the picture quality is degraded. In order to prevent the degradation of the picture quality, in the interlaced scanning, the field parity is consistent using information such as a progressive_sequence, a picture_coding_type, a top_field_first, a repeat_first_field and the like, which are parameters of the MPEG standard.

Additionally, in order to satisfy the above condition, the field delay for the duration from the decoding to the displaying is performed by one field in the single video decoding mode, and is performed by one or two fields depending on the frame rate and the display synchronous signal duration of each video in the dual video decoding mode.

For example, if the interlaced scanning is employed in the single video decoding mode and a condition of top_field_first=1 is satisfied as shown in FIG. 6(a), the decoding of the video frame is previously performed for the duration of the display synchronous signal (display_sync) of ‘1’, in order to perform the odd-number scanning for the duration of the display synchronous signal (display_sync) of ‘0’. At this time, the field delay is performed by one field. Additionally, in the dual video decoding mode, the field parity is not previously checked and the decoding is performed depending on a decoding duration. Accordingly, in the dual video decoding mode, the field delay is variable. If the field parity is not consistent in the S8, the suspended signal is set to ‘1’ in the S12, and the decoding is suspended until the next display synchronous signal (display_sync) duration.

If a variety of decoding conditions are checked through each of the above steps to satisfy all of the decoding conditions, the video decoding is performed for the picture data in the S9. The decoding of the picture data has the “SKIP” or “DEC” (decoding) condition. In case where the decoding mode is the “SKIP”, the decoding is not actually performed for current picture data and the bit stream is read from the VBV buffer memory 404. By doing so, the DTS check range can be satisfied for a continuous picture. Additionally, if the decoding of picture data is skipped, the video frame is jumped and displayed on the screen. If the decoding of the picture data is finished, it is informed the microprocessor through the interrupt that the decoding is completed.

Additionally, it is determined whether or not the video frame is additionally decoded at the current display synchronous signal duration depending on the frame rate in a step of S11. In other words, if the frame rate is 59.94, 60 frames/sec in the dual video decoding mode, one more video frame is decoded.

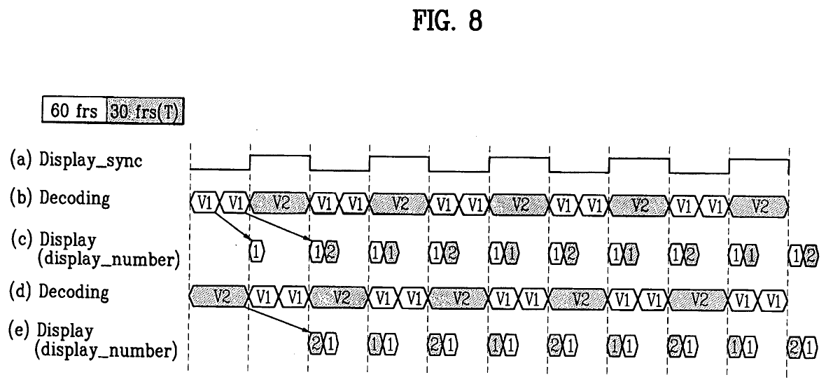

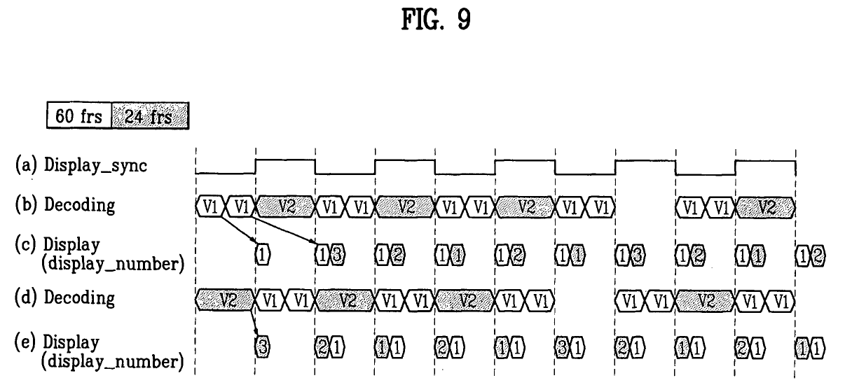

In case where the frame rate is 60 frames/sec as shown in FIGS. 8 and 9, two video frames are decoded for one display synchronous signal duration, in order to prevent the image loss when the decoded data is displayed on the screen.

Hereinafter, preferred embodiments of the single video decoding mode and the dual video decoding mode in which the decoding controller 420 controls each of the decoding blocks and the operations as in FIG. 5 are in detail described with reference to FIGS. 6 to 9.

FIGS. 6(a) to (c) are preferred embodiments of the single video decoding mode.

It is assumed that the display synchronous signal (display_sync) is odd-number scanned at the duration of 0 and is even-number scanned at the duration of 1, for example. Further, in a modified example, the display synchronous signal (display_sync) has a cycle of 30 Hz to be applied to a variety of frame rates.

Additionally, the display_number provided as means for controlling the video decoding and displaying has a different value depending on the frame rate and the header information to allow the consistence of the field parity, and to control the frame rate. At this time, an initial value of the display_number for a new display frame is shown, for example, in below Table 1.

TABLE 1

| Progressive | | | |
|---|---|---|---|
| sequence | Repeat first field | Top_field_first | Display_number |
| 1 | 0 | 0 | 1 |
| | 1 | 0 | 2 |
| | 1 | 1 | 3 |
| 0 | 0 | 0 | 2 |
| | 1 | 0 | 3 |
| | 1 | 1 | 3 |

In the Table 1, if the progressive sequence has a value of 1, it is a parameter of meaning the progressive scanning. If the progressive sequence has a value of 0, it is a parameter of meaning the interlaced scanning. The repeat first field is a parameter of meaning the repetition of a first field. Additionally, the top_field_first is a parameter of determining whether or not any field is first displayed in the frame picture. If the top_field_first is ‘1’, a top field is first displayed, and if the top_field_first is ‘0’, a bottom field is first displayed. Additionally, the display_number is a parameter of meaning the number of the frames to be repeated, and is reduced by one whenever a corresponding frame is display.

In other words, the Table 1 can be applied in case where the frame rate is 30 or 60 frames/sec, the progressive scanning is employed and a picture structure (picture_structure) is a frame picture. In another example where the frame rate is 24 frames/sect, the display_number alternately has a value of 2 or 3.

Additionally, the display_number designated suitably to a characteristic of the display frame is reduced by one every display synchronous signal (display_sync) duration. If the display_number is zero, the video should be changed to a new display frame to be naturally displayed without screen stop. Further, if the video decoding system is in an operation initiation state, the display_number is initialized to zero to be in a decoding preparation state. If the decoding for the new video frame is completed, the new display_number is designated. Additionally, such new display information is transmitted to a subsequent processing unit. At this time, the display_number is zero in the course of the decoding of the video. If the display_number of ‘0’ is continued above one field, it means that the underflow is generated at the VBV buffer memory. In this case, the previous video frame continues to be displayed to express a still image on the screen.

FIG. 6(a) illustrates an example of the single video decoding where the moving picture is in the interlaced scanning (progressive_sequence=0), the frame rate is 30 frames/sec and the odd-number scanning is prioritized (top_field_first=1). First of all, the decoding is performed for a first picture header to extract necessary MPEG parameters and control a subsequent decoding depending on this information. Since a condition of display_number=0 is satisfied in an initial state, the decoding is performed for the header for the duration of the display_sync of ‘0’ in the initial state (V1(H)). Due to the top_field_first is ‘1’, it is waited until the duration of the display_sync=1, and the decoding for the picture data is performed in order to allow the consistence of the field parity (V1(D)). If the picture data is displayed during the next display_sync duration, the field parity is consistent suitably to the characteristic of the top_field_first=1.

Additionally, in case where the frame rate is 30 frames/sec, the display field number should be two. Therefore, the display_number has a value of 2 at a first field of the new video frame and has a value of 1 at a second field of the new video frame. By the display_number, the decoding initiation of the new video frame and the displaying initiation of the previously decoded video frame are controlled. In case where the display_number is 0 or 1, the decoding is initiated. In case where the display_number is zero, the display information is transmitted. This decoding condition is applied to all of the single video decoding.

FIG. 6(b) illustrates the control of the decoding and displaying for the single moving picture having a 24-frame rate of the progressive scanning (progressive_sequence=1). A method of decoding the moving picture having the 24-frame rate by using the display synchronous signal (display_sync) of 30 Hz is similar with a 3:2 pull-down way. In other words, the display_number is allowed to repeatedly have a value of 3 or 2 in number, thereby decoding 24 frames at the display synchronous signal (display_sync) of 30 Hz.

Even at this time, the display_number is zero in the initial state in the same manner as FIG. 6(a). Therefore, the decoding is performed for the first picture header for the duration of the display synchronous signal (display_sync) of ‘0’ in the initial state, to extract the necessary parameter information. Additionally, since the progressive scanning is employed in FIG. 6(b), it does not need to allow the consistence of the field parity. Accordingly, the data decoding is directly performed. Subsequently, the display_number alternately has the value of 3 or 2 in order to control the frame rate.

FIG. 6(c) illustrates the control of the decoding and displaying of the moving picture having the frame rate of 60 frames/sec in the progressive scanning (progressive_sequence=1). In order to decode and display 60 frames at the display synchronous signal of 30 Hz, the decoding should be performed at each of display synchronous signal durations.

J The decoding is performed for the first picture header for the duration of display_number=0 and display_sync=0, to extract the necessary parameter information. Even at this time, since the progressive scanning is employed, the decoding and the displaying are performed irrespective of the display_sync duration. Since the display_number has the value of 1 for the displaying of the new video frame, the decoding and the displaying are performed every duration.

FIGS. 7 to 9 illustrate preferred embodiments of the dual video decoding. As in the single video decoding, the display_sync represents a display field duration of 30 Hz, and the display_number is used to control the frame rate of each video. The display_number is given a specific value when the new video frame is displayed depending on the frame rate. Further, in order to prevent the image breakdown caused by the overlapping of a currently decoded video frame and a displayed video frame, four or more video frames are used for decoding.

FIG. 7 illustrates the dual video decoding for the 24-frame moving picture (V1) of the progressive scanning and the 30-frame moving picture (V2) of the interlaced scanning. In the dual video decoding mode, the display synchronous signal (display_sync) duration for which the decoding is performed for each video ID is determined as a specific value. Accordingly, in the (b) and (c), the moving picture (V1) is decoded for the duration of the display synchronous signal (display_sync) of ‘0’, and the moving picture (V2) is decoded for the duration of the display synchronous signal (display_sync) of ‘1’. In the (c) and (d), on the contrary, the moving picture (V1) is decoded for the duration of the display synchronous signal (display_sync) of ‘1’, and the moving picture (V2) is decoded for the duration of the display synchronous signal (display_sync) of ‘0’. This illustrates the separating and the decoding of the two moving pictures. At this time, the 24-frame moving picture is decoded in a similar manner with the 3:2 pull-down by repeating 3 and 2 as the display_number in the same manner as the single video decoding.

Additionally, if the display synchronous signal (display_sync) duration is determined, the frame rate is controlled by the display_number of the corresponding video ID. The decoding is preformed when the condition of display_number<3 is satisfied. In the dual video decoding mode, the field delay for the duration from the decoding to the displaying is variable depending on how information such as the scanning way and the frame rate, and the display_sync duration are determined. For example, in FIGS. 7(b)(c), the field delay for the duration from the decoding to the displaying of the moving picture (V1) is preformed by one field at the first video frame and by two fields at the second video frame. The field delay is variably performed at a subsequent video frame. On the contrary, the moving picture (V2) is the 30-frame moving picture of the interlaced scanning with the even-number scanning prioritized (top_field_first=0). In the moving picture (V2), the field parity is consistent to perform the decoding, and the field delay is performed by two fields.

FIG. 8 illustrates an example of the dual video decoding of the 60-frame moving picture (V1) of the progressive scanning and the 30-frame moving picture (V2) of the interlaced scanning. The moving picture having the 60 frames should be displayed for the display_sync duration. Accordingly, if the display_number is determined as ‘1’, an effect of the 60-frame rate is obtained. However, since the display synchronous signal of 30 Hz is used, two video frames are decoded at one display_sync duration as shown in the drawings in order to secure a time for allowing the decoding of another moving picture.

That is, in FIGS. 8(b) and (c), the moving picture (V1) having the 60 frames is decoded for the duration of the display_sync of ‘0’, and the moving picture (V2) of the 30 frames is decoded for the duration of the display_sync of ‘1’. In FIGS. 8(d) and (e), the two moving pictures are split and decoded for an opposite display_sync duration to the (b)(c). Since the moving picture (V1) uses the progressive scanning having the 60 frames, the decoding is performed for two video frames irrespective of the field parity. At this time, a first one of the decoded two frames is delayed by one field, and a second one is delayed by two fields for displaying. Since the moving picture (V2) uses the interlaced scanning with the odd-number scanning prioritized (top_field_first=1), the field parity is consistent for displaying, and the field delay is performed by one field. In the same manner as FIG. 7, the decoding condition of the two moving pictures is the corresponding display_sync duration. If the condition of display_number<3 is satisfied, the corresponding video frame is decoded.

FIG. 9 illustrates an example of the dual video decoding of the 60-frame moving picture (V1) of the progressive scanning and the 24-frame moving picture (V2) of the progressive scanning. In FIGS. 9(b) and (c), the moving picture (V1) is decoded for the duration of the display_sync of ‘0’, and the moving picture (V2) is decoded for the duration of the display_sync of ‘1’. Whereas, in FIGS. 9(d) and (e), two moving pictures are split and decoded for an opposite display_sync duration to the (b) and (c).

At this time, since the moving picture (V1) has the frame rate of 60 frames/sec, the two video frames are decoded for one display_sync duration in order to display the moving picture every display_sync duration. Additionally, since the moving picture has the frame rate of 24 frames/sec, the decoding is performed by alternating 3 and 2 as the display_number. Even in FIG. 9, when the display_sync duration is determined for the each moving picture and the condition of display_number<3 is satisfied, the decoding is performed for a current video frame.

As described above, the display_sync and the display_number are used to perform the decoding while allowing the display field parity to be consistent in the single video decoding mode and the dual video decoding mode. In the single video decoding mode, when the display delay is constantly performed by one field, the display field is suitable, and the condition of display number<2 is satisfied, the decoding is performed. In the dual video decoding mode, when the field delay is variable, the display_sync has a predetermined duration, and the condition of display_number<3 is satisfied, the decoding is performed.

At this time, the corresponding video ID is decoded only for the display_sync duration so that the decoding of the two moving pictures are not interfered with each other in the dual video decoding mode. By doing so, if the underflow is generated at the VBV buffer memory of one video ID, the decoding can be stably performed for a next video ID without waiting until the buffer memory is filled.

As described above, the high-definition dual video decoder and the decoding method thereof according to the present invention have an effect in that one video decoder, which can be cheaply embodied, is used to concurrently decode the two HD compression moving pictures without the image loss to reduce a complexity of the circuit and reduce the cost.

Further, the high-definition dual video decoder and the decoding method thereof according to the present invention have an effect in that the stable single video decoding is not only performed, but also the two moving pictures are independently separated and decoded using the display synchronous signal to secure stable two-channel operation and allow a user to select a variety of the restored images.

Specifically, the high-definition dual video decoder and the decoding method thereof according to the present invention have an effect in that one video decoder shares the main operation circuit and control circuit in the dual video decoding mode to restore the two compression moving pictures inputted through the different channels or paths with a maximal independency secured.

Additionally, the high-definition dual video decoder and the decoding method thereof according to the present invention have an effect in that the display synchronous signal (display_sync) is used to separate the dual video decoding so that the erroneous bit stream of each video, the underflow or the overflow caused by erroneous transmission, the erroneous decoding, and the like do not have influence on the decoding of the video bit streams different from one another.

Further, the high-definition dual video decoder and the decoding method thereof according to the present invention have an effect in that the number of the synchronous signals (display_number), which should allow the display of the restored image, is used as means for controlling the frame rate in the decoding course, to display the restored moving picture without the image cutoff or the image delay.

Further, the high-definition dual video decoder and the decoding method thereof according to the present invention have an effect in that when the restored image is displayed by the decoding control, the parity of the display field is consistent to output the restored image on the screen, thereby preventing the degradation of the picture quality.

Additionally, the high-definition dual video decoder and the decoding method thereof according to the present invention have an effect in that the frame memory used for the decoding of each video is provided four or more in number to perform the dual video decoding without the image breakdown.

Further, the high-definition dual video decoder and the decoding method thereof according to the present invention have an effect in that the two frames are decoded for one display_sync duration for the compression moving picture having the frame rates of 59.94 and 60 frames/sec in the dual video decoding, to prevent an error diffusion between the videos and maintain the normal display frame rate.

It will be apparent to those skilled in the art that various modifications and variations can be made in the present invention. Thus, it is intended that the present invention covers the modifications and variations of this invention provided they come within the scope of the appended claims and their equivalents.

1. A dual video decoder of a digital broadcasting receiver having first and second system decoders for decoding and outputting first and second video PESs (Packetized Elementary Streams) from TS (Transport Stream) bit streams of channels concurrently tuned and demodulated through first and second tuners, the decoder comprising:
a first PES decoder for decoding the first video PES outputted from the first system decoder, into a first video ES;
a second PES decoder for decoding the second video PES outputted from the second system decoder, into a second video ES;
a VBV (Video Buffer Verifier) buffer memory divided into a first video ES region and a second video ES region, for temporarily storing the first and second video ESs outputted from the first and second PES decoders, in corresponding first video ES region and second video ES region;
a decoding controller for, if a decoding mode and a display mode having image information are set, outputting a control signal to determine a to-be-decoded video ES among the first and second video ESs, and independently decode the first and second video ESs in a single decoding unit by using a display synchronous signal; and
the single decoding unit for reading the to-be-decoded video ES from the corresponding region of the VBV buffer memory in a predetermined unit of decoding under the control of the decoding controller to restore the read video ES to an original video signal through VLD (Variable Length Decoding) with synchronization to the display synchronous signal, IQ (Inverse quantizing), IDCT (Inverse Discrete Cosine Transforming), and MC (Motion Compensating).

2. The decoder of claim 1, further comprising a screen combining unit for combining and outputting first and second video signals, which are dual-decoded and outputted in a video frame unit from the single decoding unit, in the display mode.

3. The decoder of claim 1, wherein an input signal of the decoding controller at least has decoding mode information, display mode information, a frame rate and scanning information of a moving picture,
the control signal outputted from the decoding controller to the decoding unit has a decoding mode signal indicating a single video decoding mode or a dual video decoding mode, and identification information (ID) included in the to-be-decoded video ES, and
the display mode information outputted from the decoding controller to a displaying unit at least has a size of a picture to be displayed, a display mode, and memory position information of a video frame.

4. The decoder of claim 1, wherein the video signal of each of the channels tuned through the first and second tuners has a different frame rate or the same frame rate as the display synchronous signal.

5. The decoder of claim 1, wherein each of the video ESs is decoded in a video frame unit in the dual video decoding mode.

6. The decoder of claim 1, wherein the decoding controller controls the frame rate of a corresponding video frame being currently decoded, by using a display field number (display_number), the display field number being the number of the display synchronous signal that allow the displaying of the restored picture.

7. The decoder of claim 6, wherein the decoding controller allocates one of 0, 1, 2 and 3 as the display field number (display_number) depending on the frame rate every display frame of each video bit stream, and reduces a corresponding display field number (display_number) whenever a corresponding decoded video frame is outputted.

8. The decoder of claim 7, wherein the decoding controller outputs the corresponding decoded video frame with the display field number (display_number) of ‘0’ most prioritized.

9. The decoder of claim 6, wherein if a condition of display_number<2 is satisfied in the single video decoding mode and a condition of display_number<3 is satisfied in the dual video decoding mode, the decoding controller controls the single decoding unit to decode the corresponding video frame with synchronization to the display synchronous signal.

10. The decoder of claim 1, wherein the decoding controller allows a parity consistence of a display field of video decoded in the decoding unit, and outputs the decoded video.

11. The decoder of claim 10, wherein a field delay is performed by at least one field for a duration from the decoding to the displaying in the single video decoding mode and is performed by at least one field or two fields for the duration from the decoding to the displaying depending on the frame rate and a decoding synchronous signal duration of each video in the dual video decoding mode, in order to allow the consistence of the display field.

12. The decoder of claim 10, wherein in case where a source of a to-be-decoded video frame is an interlaced scanning, and a to-be-currently-displayed field parity for the to-be-decoded video frame and a field parity of the display synchronous signal is not consistent with each other, the decoding controller suspends the decoding of the to-be-decoded video frame to allow the consistence of the two fields parity.

13. The decoder of claim 1, wherein in case where the display synchronous signal of 30 Hz is used, the decoding controller decodes two video frames of a compression moving picture having frame rates of 59.94 and 60 frames/sec for one display synchronous signal duration in the dual video decoding mode.

14. A dual video decoding method of a digital broadcasting receiver in which first and second video ESs are extracted from video PESs of first and second channels, which are concurrently tuned and demodulated through first and second tuners, and stored in a VBV (Video Buffer Verifier) buffer memory, and the stored first and second video ESs are decoded through a single video decoder, the method comprising the steps of:
(a) if a decoding mode and a display mode having image information are set, determining a to-be-decoded video ES among the first and second video ESs, and waiting a predetermined transition state of a display synchronous signal;
(b) checking the frame rate of the determined to-be-decoded video ES by using a display field number (display_number) determined suitably to the display synchronous signal in a transition state of the display synchronous signal, and performing a next decoding or waiting without the decoding until a next display synchronous signal duration;
(c) decoding picture header information of a corresponding video frame in case where it is determined that a previous decoding is not in a suspended state by using an indication signal informing of suspended decoding, and bypassing the decoding of the picture header information in case where it is determined that the previous decoding is in the suspended state;
(d) comparing a DTS (Decoding Time Stamp), which is inserted into the corresponding video frame, with a STC (System Time Clock), which is calculated by an entire reference clock of the receiver, to determine whether or not to correspond to any one of waiting, skip and decoding states;
(e) in case where it is determined to correspond to the waiting state, setting the indication signal, which informs of the suspended decoding, to ‘1’, and waiting without the decoding until the next display synchronous signal duration; and
(f) skipping the decoding of the determined to-be-decoded video ES in a predetermined unit of decoding in case where it is determined to correspond to the skip state, and performing the determined to-be-decoded video ES in a video frame unit in case where it is determined to correspond to the decoding state.

15. The method of claim 14, wherein in the (b) step, the next decoding is performed to synchronize the corresponding video frame to the display synchronous signal to decode the synchronized corresponding video frame in case where a condition of display_number<2 is satisfied in a single video decoding mode and a condition of display_number<3 is satisfied in a dual video decoding mode, and waiting without the decoding until the next display synchronous signal duration in case where the conditions are not satisfied.

16. The method of claim 14, the (f) step comprises the steps of:
in case where it is determined that the inputted source is an interlaced scanning moving picture while being in the decoding state in the (d) step, checking whether or not a to-be-currently-displayed field parity for each video bit stream and a field parity of the display synchronous signal is consistent with each other; and
only in case where it is determined that two fields parity is consistent, decoding the corresponding video frame, and in case where it is determined that they is not consistent, setting the indication signal to ‘1’ and suspending the decoding until the next display synchronous signal duration.

17. The method of claim 14, wherein in case where the display synchronous signal of 30 Hz is used, the decoding controller decodes two video frames of a compression moving picture having frame rates of 59.94 and 60 frames/sec for one display synchronous signal duration in the dual video decoding mode.

18. The method of claim 14, wherein the (a) step further comprises a step of waiting until the next display synchronous signal duration if the video ES sufficient for decoding is not stored in the VBV buffer memory.

19. A digital broadcasting receiver comprising:
a first tuner for tuning one of a plurality of channel signals received through an antenna, to demodulate the tuned channel signal to a first TS (Transport Stream) bit stream;
a second tuner for tuning one of the plurality of channel signals received through the antenna, to demodulate the tuned channel signal to a second TS bit stream;
a first system decoder for decoding a first video PES from the demodulated first TS bit steam, and outputting the decoded first video PES;
a second system decoder for decoding a second video PES from the demodulated second TS bit steam, and outputting the decoded second video PES;
a single video decoder for decoding each of the first and second video PESs outputted from the first and second system decoders into the video ESs, and determining a to-be-decoded video ES among the first and second video ESs depending on the decoding mode and the display mode, and decoding the determined to-be-decoded video ES in a video frame unit at a predetermined transition state of a display synchronous signal; and
a screen combining unit for combining and outputting first and second video signals, which are dual-decoded and outputted in the video frame unit from the single video decoder, in the display mode.

20. The receiver of claim 19, wherein the single video decoder comprises:
a first PES decoder for decoding the first video PES outputted from the first system decoder, into the first video ES;
a second PES decoder for decoding the second video PES outputted from the second system decoder, into the second video ES;
a VBV (Video Buffer Verifier) buffer memory divided into a first video ES region and a second video ES region, for temporarily storing the first and second video ESs outputted from the first and second PES decoders, in corresponding first video ES region and second video ES region;
a decoding controller for, if the decoding mode and the display mode having image information are set, outputting a control signal to determine the to-be-decoded video ES among the first and second video ESs, and independently decode the first and second video ESs in a decoding unit by using the display synchronous signal; and
the decoding unit for reading the to-be-decoded video ES from the corresponding region of the VBV buffer memory in a predetermined unit of decoding under the control of the decoding controller to restore the read video ES to an original video signal through VLD (Variable Length Decoding) with synchronization to the display synchronous signal, IQ (Inverse quantizing), IDCT (Inverse Discrete Cosine Transforming), and MC (Motion Compensating)

21. The receiver of claim 20, wherein the decoding controller controls to wait until a next display synchronous signal duration if the video ES sufficient for decoding is not stored in the VBV buffer memory.

22. The receiver of claim 19, wherein the decoding controller controls to check whether or not a to-be-currently-displayed field parity for each video bit stream and a field parity of the display synchronous signal is consistent, and if it is determined that they is not consistent, the decoding controller controls to suspend the decoding until the next display synchronous signal duration.
